(19) United States
(12) Patent Application Publication
(10) Pub. No.: US 2013/0343760 A1
(43) Pub. Date: Dec. 26, 2013

(54) SYSTEM AND METHOD FOR OPTICAL TRANSMISSION

(71) Applicant: INDUSTRIAL TECHNOLOGY RESEARCH INSTITUTE, Hsinchu (TW)

(72) Inventors: Hsing-Yu Chen, Taipei City (TW); Chien-Hung Yeh, Hsinchu City (TW)

(73) Assignee: INDUSTRIAL TECHNOLOGY RESEARCH INSTITUTE, Hsinchu (TW)

(21) Appl. No.: 13/652,489

(22) Filed: Oct. 16, 2012

(30) Foreign Application Priority Data
Jun. 20, 2012 (TW) 101122045

(51) Int. Cl. H04J 14/00

(52) U.S. Cl. 398/91

(57) ABSTRACT

A system and a method for optical transmission are provided. The system includes a power combiner, a laser light source, a negative chirp modulator, and multiple transmission units. Each transmission unit corresponds to a frequency band and generates a first output signal in the frequency band based on orthogonal frequency-division multiplexing (OFDM). The frequency bands are not overlapped with each other. The power combiner is coupled to each transmission unit. The power combiner combines each of the first output signals to generate a second output signal. The negative chirp modulator is coupled to the power combiner and the laser light source. The negative chirp modulator performs negative chirp modulation on the laser light source with the second output signal to generate a light signal and outputs the light signal to an optical fiber.

### CROSS-REFERENCE TO RELATED APPLICATION

This application claims the priority benefit of Taiwan application serial no. 101122045, filed on Jun. 20, 2012. The entirety of the above-mentioned patent application is hereby incorporated by reference herein and made a part of this specification.

### TECHNICAL FIELD

The disclosure relates to a system and a method for optical transmission.

### BACKGROUND

A passive optical network (PON) belongs to a broadband network standard of a new generation, which can be applied to nowadays popular fiber to the home (FTTH) network architectures. Today's users have become accustomed to use networks to download large files such as videos, games or application programs, etc., which leads to an increasing demand for network bandwidth, so that the bandwidth and data transmission rate of the PON has to be continuously increased. If only the data transmission rate is to be increased, several technical solutions can be used to for accomplishment.

A first technical solution is to directly increase a speed of on-off keying modulation widely used by the current network systems.

A second technical solution is referred to as a wavelength division multiplexing passive optical network (WDM-PON), in which a plurality of low speed PONs respectively use different wavelengths to transmit signals through a single fiber. Namely, multiple low speed PONs are used to form a high speed PON.

A third technical solution is an orthogonal frequency division multiple access passive optical network (OFDMA-PON), in which quadrature amplitude modulation (QAM) is used in collaboration with orthogonal frequency division multiplexing (OFDM) signals.

### SUMMARY

The disclosure is directed to a system and a method for optical transmission, by which a single light source and low cost components are used to increase a data transmission rate of a passive optical network.

The disclosure provides an optical transmission system including a power combiner, a laser light source, a negative chirp modulator, and a plurality of transmission units. Each of the transmission units corresponds to one of a plurality of frequency bands and generates a first output signal in the corresponding frequency band by using orthogonal frequency division multiplexing (OFDM) modulation. The plurality of frequency bands do not overlap with each other. The power combiner is coupled to each of the transmission units, and combines the first output signal generated by each of the transmission units to generate a second output signal. The negative chirp modulator is coupled to the power combiner and the laser light source, and performs a negative chirp modulation on the laser light source by using the second output signal to generate a light signal, and outputs the light signal to an optical fiber.

The disclosure provides an optical transmission method including following steps. A first output signal is generated in each frequency band of a plurality of frequency bands non-overlapped with each other by using OFDM modulation. The generated first output signals are combined to generate a second output signal. Negative chirp modulation is performed on a laser light source by using the second output signal to generate a light signal, and the light signal is output to an optical fiber.

In order to make the aforementioned and other features of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of an optical transmission system according to an embodiment of the disclosure.

FIG. 2 is a schematic diagram of an optical transmission system according to an embodiment of the disclosure.

FIG. 3 is a schematic diagram of a transmission unit according to an embodiment of the disclosure.

FIG. 4 is a schematic diagram of a transmitter according to an embodiment of the disclosure.

FIG. 5 is a schematic diagram of an upconverter according to an embodiment of the disclosure.

FIG. 6 is a schematic diagram of a receiving unit according to an embodiment of the disclosure.

FIG. 7 is a schematic diagram of a downconverter according to an embodiment of the disclosure.

FIG. 8 is a schematic diagram of a receiver according to an embodiment of the disclosure.

FIG. 9 is a schematic diagram of a transmission unit according to another embodiment of the disclosure.

FIG. 10 is a schematic diagram of a receiving unit according to another embodiment of the disclosure.

FIG. 11 is a frequency response diagram of light signals after optical fiber transmission according to an embodiment of the disclosure.

FIG. 12 is a flowchart illustrating an optical transmission method according to an embodiment of the disclosure.

### DETAILED DESCRIPTION OF DISCLOSED EMBODIMENTS

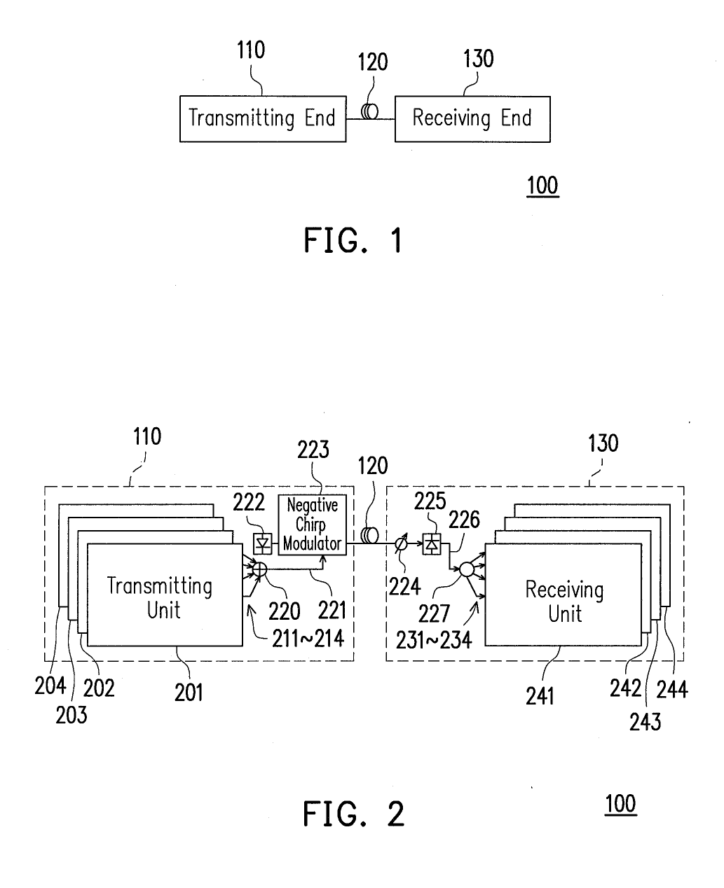

FIG. 1 is a schematic diagram of an optical transmission system 100 according to an embodiment of the disclosure. The optical transmission system 100 includes a transmitting end 110 and a receiving end 130. The transmitting end 110 and the receiving end 130 are composed of physical circuits. The transmitting end 110 and the receiving end 130 are coupled to each other through an optical fiber 120. The transmitting end 110 transmits a light signal to the optical fiber 120, and the receiving end 130 receives the light signal from the optical fiber 120. The optical transmission system 100 of the present embodiment uses a passive optical network structure, though the disclosure is not limited thereto, and in other embodiments, other types of optical network structures can also be used.

FIG. 2 is a schematic diagram of the optical transmission system 100 according to an embodiment of the disclosure. In the present embodiment, the transmitting end 110 includes four transmission units 201-204, a power combiner 220, a laser light source 222 and a negative chirp modulator 223. The power combiner 220 is coupled to each of the transmission units 201-204, and the negative chirp modulator 223 is coupled to the power combiner 220 and the laser light source 222.

Each of the transmission units 201-204 corresponds to a frequency band, and the transmission units 201-204 respectively generate output signals 211-214 in the corresponding frequency bands by using orthogonal frequency division multiplexing (OFDM) modulation. Namely, the transmission unit 201 generates the output signal 211 in a first frequency band, the transmission unit 202 generates the output signal 212 in a second frequency band, and the others are deduced by analogy. The frequency bands do not overlap with each other. The power combiner 220 combines each of the output signals 211-214 to generate an output signal 221. The negative chirp modulator 223 performs a negative chirp modulation on the laser light source 222 by using the output signal 221 to generate a light signal. The negative chirp modulator 223 converts the output signal 221 from an electric signal to the light signal, and outputs the light signal to the optical fiber 120.

The receiving end 130 of the present embodiment includes an attenuator 224, a photo receiver 225, a power splitter 227 and four receiving units 241-244. The attenuator 224 is coupled to the fiber 120, the photo receiver 225 is coupled to the attenuator 224, the power splitter 227 is coupled to the photo receiver 225, and each of the receiving units 241-244 is coupled to the power splitter 227.

The attenuator 224 controls a power of the light signal entering the photo receiver 225, so as to avoid a situation that the power of the light signal from the fiber 120 exceeds an acceptable range of the photo receiver 225. If the power of the light signal from the fiber 120 does not exceed the acceptable range of the photo receiver 225, the attenuator 224 can be omitted.

The photo receiver 225 receives the light signal output by the negative chirp modulator 223 from the fiber 120, and converts the light signal into an input signal 226. In other words, the input signal 226 is an electric signal converted from the light signal. The power splitter 227 splits the input signal 226 into four input signals 231-234, where the input signals 231-234 are all the same without difference. Each of the receiving units 241-244 receives one of the input signals 231-234. The receiving unit 241 receives the input signal 231, the receiving unit 242 receives the input signal 232, and so on.

The transmission units 201-204, the receiving units 241-244 and the frequency bands have a one-to-one corresponding relationship. In the present embodiment, a frequency band of 10 Gb/s is divided into four frequency bands of 2.5 Gb/s. Each of the transmission units 201-204 corresponds to one of the 2.5 Gb/s frequency bands, and each of the receiving units 241-244 also corresponds to one of the 2.5 Gb/s frequency bands. In other embodiments of the disclosure, each of the frequency bands may have a same or different bandwidth. The lowest frequency band in the above frequency bands may be a baseband or not a baseband.

The optical transmission system 100 of the present embodiment may use four different frequency bands, so that it includes four transmission units and four receiving units. In other embodiments of the disclosure, the number of the frequency bands is arbitrary. For example, if the optical transmission system 100 uses M different frequency bands, the optical transmission system 100 then includes M transmission units and M receiving units. Each of the transmission units corresponds to one of the M frequency bands and generates an output signal in the corresponding frequency band, and the power combiner 220 combines M output signals. Moreover, the power splitter 227 splits the input signal converted by the photo receiver 225 into M input signals, where each of the receiving unit corresponds to one of the M frequency bands and receives one of the M input signals, and M can be any integer greater than or equal to two.

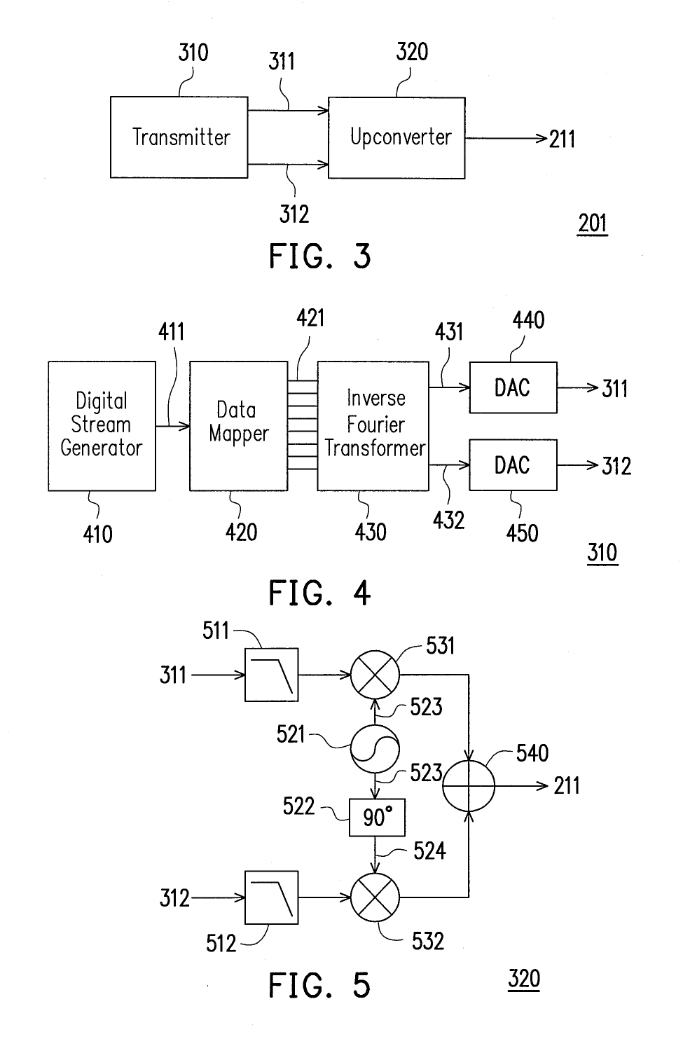

FIG. 3 is a schematic diagram of the transmission unit 201 according to an embodiment of the disclosure. In the present embodiment, the optical transmission system 100 does not use the baseband, and the structures of the transmission units 201-204 are the same. The transmission unit 201 is taken as an example for descriptions, and descriptions of the other transmission units are not repeated.

The transmission unit 201 of the present embodiment includes a transmitter 310 and an upconverter 320. The upconverter 320 is coupled between the transmitter 310 and the power combiner 220. The transmitter 310 generates a real signal 311 and an imaginary signal 312 in a baseband by using quadrature amplitude modulation (QAM) and orthogonal frequency division multiplexing (OFDM) modulation. The upconverter 320 upconverts frequencies of the real signal 311 and the imaginary signal 312 from the baseband to a frequency band corresponding to the transmission unit 201, and combines the real signal 311 and the imaginary signal 312 to generate the output signal 211.

FIG. 4 is a schematic diagram of the transmitter 310 according to an embodiment of the disclosure. The transmitter 310 may modulate an OFDM modulation signal in the baseband by using the QAM. In the present embodiment, the transmitter 310 includes a digital stream generator 410, a data mapper 420, an inverse Fourier transformer 430 and digital-to-analog converters (DACs) 440 and 450. The data mapper 420 is coupled to the digital stream generator 410, the inverse Fourier transformer 430 is coupled to the data mapper 420, the DAC 440 is coupled between the inverse Fourier transformer 430 and the upconverter 320, and the DAC 450 is also coupled between the inverse Fourier transformer 430 and the upconverter 320.

The digital stream generator 410 generates a serial digital stream 411, where the serial digital stream 411 contains information to be transmitted to the receiving end 130. In other embodiments of the disclosure, the serial digital stream 411 can be provided from external of the transmitter 320, and in this case, the transmitter 310 does not include the digital stream generator 410.

The data mapper 420 converts the serial digital stream 411 into a plurality of parallel digital streams through demultiplexing, and maps each of the parallel digital streams to one of a plurality of symbol streams 421 by using a QAM constellation. The data mapper 420 may use a 4×4 or a larger QAM constellation, for example, an 8×8 or a 16×16 QAM constellation.

The inverse Fourier transformer 430 performs inverse Fourier transform (IFT) or inverse fast Fourier transform (IFFT) on the symbol streams 421 to generate a real sample sequence 431 and an imaginary sample sequence 432. The DAC 440 converts the real sample sequence 431 from digital signal into analog signal to generate the real signal 311. The DAC 450 converts the imaginary sample sequence 432 from digital signal into analog signal to generate the imaginary signal 312.

FIG. 5 is a schematic diagram of the upconverter 320 according to an embodiment of the disclosure. The upconverter 320 of the present embodiment includes low-pass filters (LPFs) 511 and 512, a sine wave generator 521, a phase shifter 522, mixers 531 and 532 and a power combiner 540. The LPF 511 is coupled to the transmitter 310, the LPF 512 is also coupled to the transmitter 310, the phase shifter 522 is coupled to the sine wave generator 521, the mixer 531 is coupled to the LPF 511 and the sine wave generator 521, the mixer 532 is coupled to the LPF 512 and the phase shifter 522, and the power combiner 540 is coupled to the mixers 531 and 532 and the power combiner 220.

The LPF 511 filter out noises of the real signal 311 outside the baseband, and the LPF 512 filter out noises of the imaginary signal 312 outside the baseband. The sine wave generator 521 provides carrier signals 523. The phase shifter 522 shifts a phase of the carrier signal 523 of one branch by 90 degrees to generate a carrier signal 524, where phases of the carrier signals 523 and 524 are orthogonal. Then, the mixer 531 multiplies the real signal 311 by the carrier signal 523 to upconvert the frequency of the real signal 311 from the baseband to a frequency band corresponding to the transmission unit 201. The mixer 532 multiplies the imaginary signal 312 by the carrier signal 524 to upconvert the frequency of the imaginary signal 312 from the baseband to the frequency band corresponding to the transmission unit 201. Then, the power combiner 540 combines the real signal 311 and the imaginary signal 312 to generate the output signal 211.

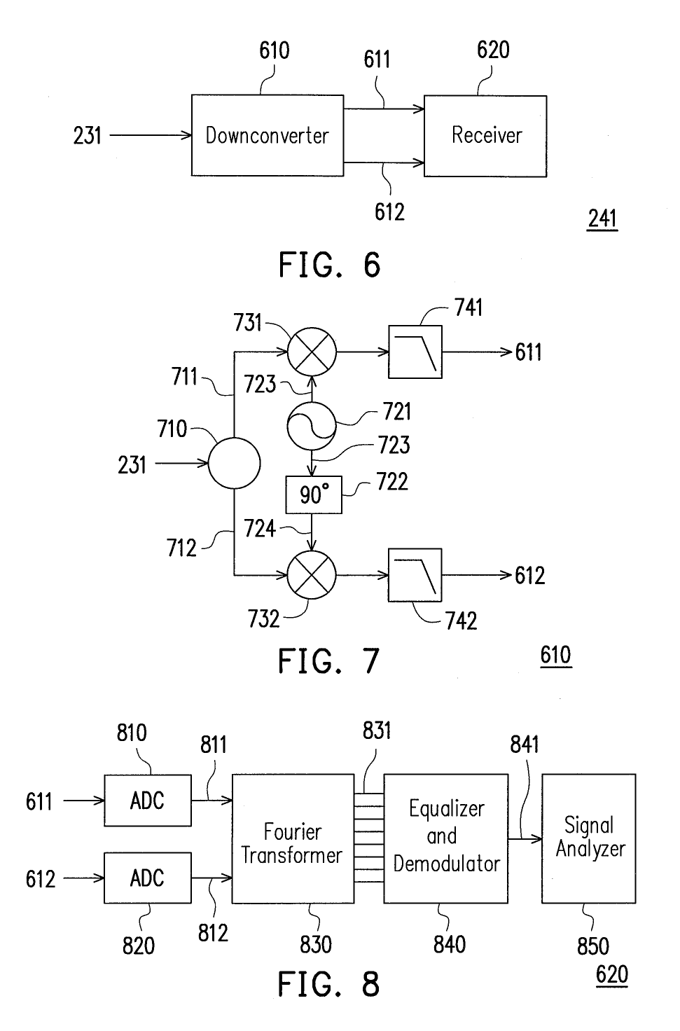

FIG. 6 is a schematic diagram of the receiving unit 241 according to an embodiment of the disclosure. In the present embodiment, the optical transmission system 100 does not use the baseband, and the structures of the receiving units 241-244 are the same. The receiving unit 241 is taken as an example for descriptions, and descriptions of the other receiving units are not repeated.

The receiving unit 241 of the present embodiment includes a downconverter 610 and a receiver 620. The downconverter 610 is coupled to the power splitter 227, and the receiver 620 is coupled to the downconverter 610. The downconverter 610 downconverts the frequency of the input signal 231 from the frequency band corresponding to the receiving unit 241 to the baseband, and divides the input signal 231 into a real signal 611 and an imaginary signal 612. The receiver 620 receives the real signal 611 and the imaginary signal 612.

FIG. 7 is a schematic diagram of the downconverter 610 according to an embodiment of the disclosure. The downconverter 610 of the present embodiment includes a power splitter 710, a sine wave generator 721, a phase shifter 722, mixers 731 and 732 and LPFs 741 and 742. The power splitter 710 is coupled to the power splitter 227, the phase shifter 722 is coupled to the sine wave generator 721, the mixer 731 is coupled to the power splitter 710 and the sine wave generator 721, the mixer 732 is coupled to the power splitter 710 and the phase shifter 722, the LPF 741 is coupled between the mixer 731 and the receiver 620, and the LPF 742 is coupled between the mixer 732 and the receiver 620.

The power splitter 710 splits the input signals 231 into input signals 711 and 712. The sine wave generator 721 provides carrier signals 723, and the phase shifter 722 shifts a phase of the carrier signal 723 of one branch by 90 degrees to generate a carrier signal 724, where phases of the carrier signals 723 and 724 are orthogonal. Then, the mixer 731 multiplies the input signal 711 by the carrier signal 723 to downconvert the frequency of the input signal 711 from a frequency band corresponding to the receiving unit 241 to the baseband. The mixer 732 multiplies the input signal 712 by the carrier signal 724 to downconvert the frequency of the input signal 712 from the frequency band corresponding to the receiving unit 241 to the baseband. Then, the LPF 741 filters out noises of the input signal 711 outside the frequency band corresponding to the receiving unit 241 to generate the real signal 611. The LPF 742 filters out noises of the input signal 712 outside the frequency band corresponding to the receiving unit 241 to generate the imaginary signal 612.

FIG. 8 is a schematic diagram of the receiver 620 according to an embodiment of the disclosure. The receiver 620 can demodulates the OFDM signal. The receiver 620 of the present embodiment includes analog-to-digital converters (ADCs) 810 and 820, a Fourier transformer 830, an equalizer and demodulator 840 and a signal analyzer 850. The ADCs 810 and 820 are coupled to the downconverter 610, the Fourier transformer 830 is coupled to the ADCs 810 and 820, the equalizer and demodulator 840 is coupled to the Fourier transformer 830, and the signal analyzer 850 is coupled to the equalizer and demodulator 840.

The ADC 810 converts the real signal 611 from an analog signal to a digital signal to generate a real sample sequence 811, and the ADC 820 converts the imaginary signal 612 from an analog signal to a digital signal to generate an imaginary sample sequence 812. The Fourier transformer 830 performs Fourier transform (FT) or fast Fourier transform (FFT) on the real sample sequence 811 and the imaginary sample sequence 812 to generate a plurality of symbol streams 831. The equalizer and demodulator 840 compensates a channel effect of the symbol streams 831, and demodulates the symbol streams 831 to generate a serial digital stream 841. The signal analyzer 850 receives and analyzes the serial digital stream 841, and extracts important information of the serial digital stream 841 for post operations. In other embodiments of the disclosure, the signal analyzer 850 can be independent to the receiver 620. In this case, the receiver 620 does not include the signal analyzer 850.

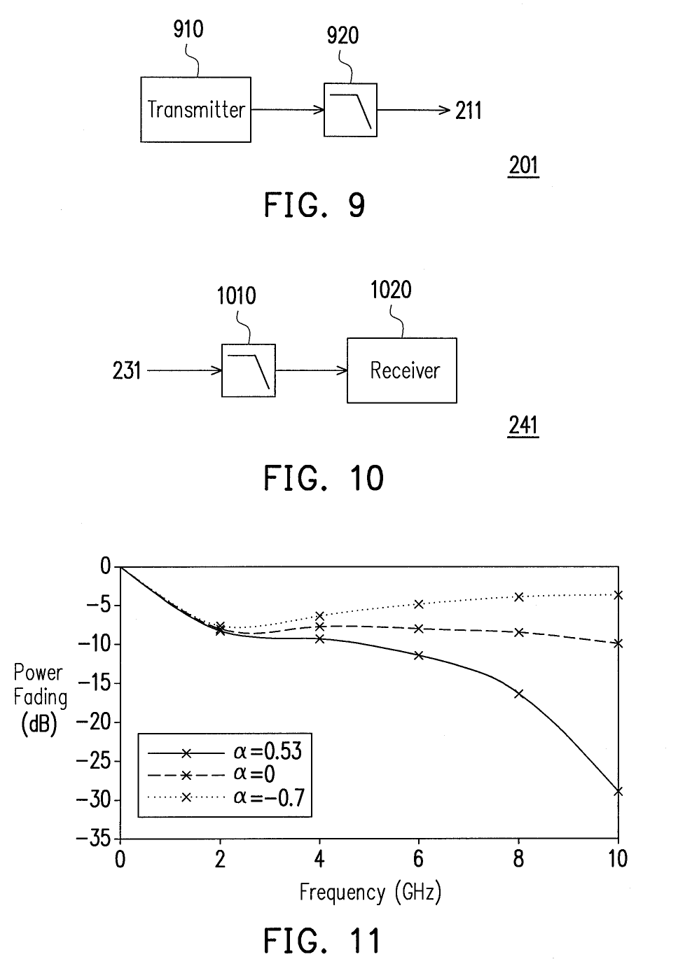

FIG. 9 is a schematic diagram of the transmission unit 201 according to another embodiment of the disclosure. The lowest frequency band used by the optical transmission system 100 of the present embodiment is the baseband, and the transmission unit 201 corresponds to the baseband. The transmission unit 201 directly generates the output signal 211 in the baseband without using an upconverter, so that a structure thereof is relatively simple, which is as that shown in FIG. 9. The frequency bands corresponding to the other transmission units 202-204 are not the baseband, so that the structures of the transmission units 202-204 are still as that shown in FIG. 3 to FIG. 5.

The transmission unit 201 of the present embodiment includes a transmitter 910 and a LPF 920, where the LPF 920 is coupled between the transmitter 910 and the power combiner 220. The transmitter 910 generates the output signal 211 in the baseband by using the QAM and the OFDM modulation, and the LPF 920 filters out noises of the output signal 211 outside the baseband. A structure of the transmitter 910 is similar to that of the transmitter 310 of FIG. 3, and a difference there between is that the real signal and the imaginary signal performed with the IFT, the IFFT and the digital to analog conversion are combined to output as the output signal 211, and details thereof are not repeated.

FIG. 10 is a schematic diagram of a receiving unit 241 according to another embodiment of the disclosure. The lowest frequency band used by the optical transmission system 100 of the present embodiment is the baseband, and the receiving unit 241 corresponds to the baseband. The receiving unit 241 directly receives the input signal 231 in the baseband without using an upconverter, so that a structure thereof is relatively simple, which is as that shown in FIG. 10. The frequency bands corresponding to the other receiving units 242-244 are not the baseband, so that the structures of the receiving units 242-244 are still as that shown in FIG. 6 to FIG. 8.

The receiving unit 241 of the present embodiment includes a LPF 1010 and a receiver 1020. The LPF 1010 is coupled to the power splitter 227, and the receiver 1020 is coupled to the LPF 1010. The LPF 1010 filters out the noises of the input signal 231 outside the baseband, and the receiver 1020 receives the input signal 231.

A structure of the receiver 1020 is similar to the receiver 620 of FIG. 8, and a difference there between is that the real signal and the imaginary signal are combined, and an analog to digital conversion is performed thereof, and the other details thereof are not repeated.

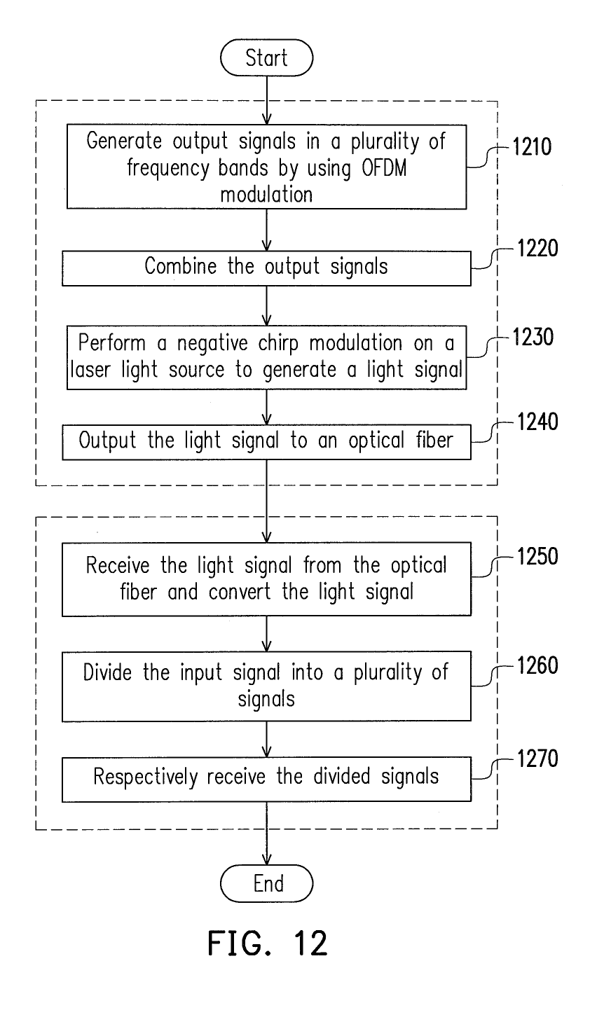

FIG. 11 is a frequency response diagram of three light signals performed with positive chirp modulation (α=0.53), zero chirp modulation (α=0) and negative chirp modulation (α=−0.7) after 20 kilometres single-mode optical fiber transmission. As shown in FIG. 11, the negative chirp modulation of the negative chirp modulator 223 not only greatly ameliorates the phenomenon of signal power fading caused by fiber dispersion in long distance transmission of the light signal in the optical fiber 120, but also has a gain in high frequency signal transmission.

The transmission units 201-204 use 4×4 QAM, which may achieve a data transmission rate of 10 Gb/s by using a signal frequency of 2.5 GHz. By combining the four frequency bands of 10 Gb/s, the light signal output by the negative chirp modulator 223 may have a data transmission rate of 40 Gb/s, and only a specification of 10 Gb/s of the negative chirp modulator 223 is required without requiring a modulation capability of 40 Gb/s. In this way, the light signal can be transmitted for 20 kilometres in the optical fiber 120 without signal power fading.

Since the output signal of each frequency band is generated in the baseband, the DAC and ADC for processing the individual frequency band only require a sampling rate of 5 GS/s and a resolution of 5 bits.

FIG. 12 is a flowchart illustrating an optical transmission method according to an embodiment of the disclosure. First, in step 1210, a first output signal is generated in each frequency band of a plurality of frequency bands non-overlapped with each other by using OFDM modulation. The first output signals are combined to generate a second output signal. In step 1220, the first input signals are combined to generate a second output signal. In step S1230, a negative chirp modulation is performed on a laser light source by using the second output signal to generate a light signal. In step 1240, the light signal is output to an optical fiber.

Then, in step 1250, the light signal is received from the optical fiber, and the light signal is converted into a first input signal. In step 1260, the first input signal is divided into a plurality of second input signals. Then, in step 1270, one of the second input signals is received.

The steps 1210 to 1240 correspond to the transmitting end 110, and the steps 1250 to 1270 correspond to the receiving end 130. Details of the above steps have been described in the aforementioned embodiments, which are not repeated.

In summary, in the optical transmission system and the optical transmission method of the disclosure, a plurality of OFDM modulation signals with the same wavelength and belonging to different frequency bands is used to form a high speed transmission signal. The negative chirp modulation is used to avoid power fading and fiber dispersion in long distance transmission. In this way, low cost components can be used to enhance the data transmission rate of the PON.

In the optical transmission system and the optical transmission method of the disclosure, by using the QAM and OFDM modulation of multiple frequency bands, the high transmission rate can be achieved through a laser light source of a single wavelength and optoelectronic components with a lower bandwidth. Since the output signal of each frequency band is directly generated in the baseband, the DAC and ADC of the aforementioned embodiments do not require a high sampling rate and a high resolution, which decreases the system cost and energy consumption. The aforementioned optical transmission system and the optical transmission method use the negative chirp modulation to greatly ameliorate the phenomenon of signal power fading caused by fiber dispersion in long distance transmission. If the negative chirp modulator is not used, multiple expensive devices (for example, multiple Mach-Zehnder modulators) have to be used.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. An optical transmission system, comprising:
a plurality of transmission units, each of the transmission units corresponding to one of a plurality of frequency bands and generating a first output signal in the corresponding frequency band by using orthogonal frequency division multiplexing (OFDM) modulation, wherein the frequency bands do not overlap with each other;
a first power combiner, coupled to each of the transmission units, and combining the first output signal generated by each of the transmission units to generate a second output signal;
a laser light source; and
a negative chirp modulator, coupled to the first power combiner and the laser light source, performing a negative chirp modulation on the laser light source by using the second output signal to generate a light signal, and outputting the light signal to an optical fiber.

2. The optical transmission system as claimed in claim 1, wherein one of the plurality of frequency bands is a baseband, and the one of the plurality of transmission units corresponding to the baseband comprises:
a first transmitter, generating the first output signal in the baseband by using quadrature amplitude modulation (QAM) and OFDM modulation; and
a first low-pass filter, coupled between the first transmitter and the first power combiner, and filtering out noises of the first output signal outside the baseband.

3. The optical transmission system as claimed in claim 1, wherein when the corresponding frequency band of one of the transmission units is not a baseband, the one of the transmission units comprises:
a second transmitter, generating a first real signal and a first imaginary signal in the baseband by using QAM and OFDM modulation; and
an upconverter, coupled between the second transmitter and the first power combiner, upconverting a frequency of the first real signal and the first imaginary signal from the baseband to the corresponding frequency band of the one of the transmission units, and combining the first real signal and the first imaginary signal to generate the first output signal.

4. The optical transmission system as claimed in claim 3, wherein the second transmitter comprises:
a data mapper, converting a first serial digital stream into a plurality of parallel digital streams through demultiplexing, and mapping each of the parallel digital streams to one of a plurality of first symbol streams by using a QAM constellation;
an inverse Fourier transformer, coupled to the data mapper, performing inverse Fourier transform or inverse fast Fourier transform on the first symbol streams to generate a first real sample sequence and a first imaginary sample sequence;
a first digital-to-analog converter, coupled between the inverse Fourier transformer and the upconverter, and converting the first real sample sequence from digital signal into analog signal to generate the first real signal; and
a second digital-to-analog converter, coupled between the inverse Fourier transformer and the upconverter, and converting the first imaginary sample sequence from digital signal into analog signal to generate the first imaginary signal.

5. The optical transmission system as claimed in claim 3, wherein the upconverter comprises:
a second low-pass filter, coupled to the second transmitter, and filtering out noises of the first real signal outside the baseband;
a third low-pass filter, coupled to the second transmitter, and filtering out noises of the first imaginary signal outside the baseband;
a first mixer, coupled to the second low-pass filter, and multiplying the first real signal by a first carrier signal to upconvert a frequency of the first real signal from the baseband to the corresponding frequency band of the one of the transmission units;
a second mixer, coupled to the third low-pass filter, and multiplying the first imaginary signal by a second carrier signal to upconvert a frequency of the first imaginary signal from the baseband to the corresponding frequency band of the one of the transmission units, wherein phases of the first carrier signal and the second carrier signal are orthogonal; and
a second power combiner, coupled to the first mixer, the second mixer and the first power combiner, and combining the first real signal and the first imaginary signal to generate the first output signal.

6. The optical transmission system as claimed in claim 1, further comprising:
a light receiver, receiving the light signal from the optical fiber, and converting the light signal into a first input signal;
a first power splitter, coupled to the light receiver, and splitting the first input signal into a plurality of second input signals; and
a plurality of receiving units, each of the receiving units coupled to the first power splitter and receiving one of the second input signals.

7. The optical transmission system as claimed in claim 6, wherein each of the receiving units corresponds to one of the frequency bands, one of the frequency bands is a baseband, and the one of the receiving units corresponding to the baseband comprises:
a fourth low-pass filter, coupled to the first power splitter, and filtering out noises of one of the second input signals outside the baseband; and
a first receiver, coupled to the fourth low-pass filter, and receiving said one of the second input signals.

8. The optical transmission system as claimed in claim 6, wherein each of the receiving units corresponds to one of the frequency bands, when the corresponding frequency band of one of the receiving units is not a baseband, the one of the receiving units comprises:
a downconverter, coupled to the first power splitter, and downconverting a frequency of one of the second input signals from said corresponding frequency band of the one of the receiving units to the baseband, and dividing said one of the second input signals into a second real signal and a second imaginary signal; and
a second receiver, coupled to the downconverter, and receiving the second real signal and the second imaginary signal.

9. The optical transmission system as claimed in claim 8, wherein the downconverter comprises:
a second power splitter, coupled to the first power splitter, and splitting said one of the second input signals into a third input signal and a fourth input signal;
a third mixer, coupled to the second power splitter, and multiplying the third input signal by a third carrier signal to downconvert a frequency of the third input signal from said corresponding frequency band of the one of the receiving units to the baseband;
a fourth mixer, coupled to the second power splitter, and multiplying the fourth input signal by a fourth carrier signal to downconvert a frequency of the fourth input signal from said corresponding frequency band of the one of the receiving units to the baseband, wherein phases of the third carrier signal and the fourth carrier signal are orthogonal;
a fifth low-pass filter, coupled between the third mixer and the second receiver, and filtering out noises of the third input signal outside said corresponding frequency band of the one of the receiving units, so as to generate the second real signal; and
a sixth low-pass filter, coupled between the fourth mixer and the second receiver, and filtering out noises of the fourth input signal outside said corresponding frequency band of the one of the receiving units, so as to generate the second imaginary signal.

10. The optical transmission system as claimed in claim 8, wherein the second receiver comprises:
a first analog-to-digital converter, coupled to the downconverter, and converting the second real signal from analog signal to digital signal to generate a second real sample sequence;
a second analog-to-digital converter, coupled to the downconverter, and converting the second imaginary signal from analog signal to digital signal to generate a second imaginary sample sequence;
a Fourier transformer, coupled to the first analog-to-digital converter and the second analog-to-digital converter, and performing Fourier transform or fast Fourier transform on the second real sample sequence and the second imaginary sample sequence to generate a plurality of second symbol streams; and
an equalizer and demodulator, coupled to the Fourier transformer, and compensating a channel effect of the second symbol streams, and demodulating the second symbol streams to generate a second serial digital stream.

11. An optical transmission method, comprising:
generating a first output signal in each frequency band of a plurality of frequency bands non-overlapped with each other by using orthogonal frequency division multiplexing (OFDM) modulation;
combining the generated first output signals to generate a second output signal;
performing negative chirp modulation on a laser light source by using the second output signal to generate a light signal; and
outputting the light signal to an optical fiber.

12. The optical transmission method as claimed in claim 11, wherein one of the frequency bands is a baseband, and the step of generating the first output signal by using OFDM modulation comprises:
generating the first output signal in the baseband by using quadrature amplitude modulation (QAM) and OFDM modulation; and
filtering out noises of the first output signal outside the baseband.

13. The optical transmission method as claimed in claim 11, wherein one of the frequency bands is not a baseband, and the step of generating the first output signal by using OFDM modulation comprises:
generating a first real signal and a first imaginary signal in the baseband by using QAM and OFDM modulation; and
upconverting a frequency of the first real signal and the first imaginary signal from the baseband to the one of the frequency bands, and combining the first real signal and the first imaginary signal to generate the first output signal in the one of the frequency bands.

14. The optical transmission method as claimed in claim 13, wherein the step of generating the first real signal and the first imaginary signal in the baseband by using QAM and OFDM modulation comprises:
converting a first serial digital stream into a plurality of parallel digital streams through demultiplexing;
mapping each of the parallel digital streams to one of a plurality of first symbol streams by using a QAM constellation;
performing inverse Fourier transform or inverse fast Fourier transform on the first symbol streams to generate a first real sample sequence and a first imaginary sample sequence;
converting the first real sample sequence from digital signal into analog signal to generate the first real signal; and
converting the first imaginary sample sequence from digital signal into analog signal to generate the first imaginary signal.

15. The optical transmission method as claimed in claim 13, wherein the step of upconverting the frequency of the first real signal and the first imaginary signal and combining the first real signal and the first imaginary signal to generate the first output signal comprises:
filtering out noises of the first real signal outside the baseband;
filtering out noises of the first imaginary signal outside the baseband;
multiplying the first real signal by a first carrier signal to upconvert a frequency of the first real signal from the baseband to the one of the frequency bands;
multiplying the first imaginary signal by a second carrier signal to upconvert a frequency of the first imaginary signal from the baseband to the one of the frequency bands, wherein phases of the first carrier signal and the second carrier signal are orthogonal; and
combining the first real signal and the first imaginary signal to generate the first output signal.

16. The optical transmission method as claimed in claim 11, further comprising:
receiving the light signal from the optical fiber, and converting the light signal into a first input signal;
splitting the first input signal into a plurality of second input signals; and
respectively receiving one of the second input signals.

17. The optical transmission method as claimed in claim 16, wherein each of the second input signals corresponds to one of the frequency bands, one of the frequency bands is a baseband, and the step of receiving one of the second input signals comprises:
filtering out noises of the one of the second input signals outside the baseband; and
receiving the one of the second input signals.

18. The optical transmission method as claimed in claim 16, wherein each of the second input signals corresponds to one of the frequency bands, and when the corresponding frequency band of one of the second input signals is not a baseband, the step of receiving the one of the second input signals comprises:
downconverting a frequency of said one of the second input signals from the corresponding frequency band to the baseband, and dividing said one of the second input signals into a second real signal and a second imaginary signal; and
receiving the second real signal and the second imaginary signal.

19. The optical transmission method as claimed in claim 18, wherein the step of downconverting and dividing comprises:
splitting said one of the second input signals into a third input signal and a fourth input signal;
multiplying the third input signal by a third carrier signal to downconvert a frequency of the third input signal from the corresponding frequency band of said one of the second input signals to the baseband;
multiplying the fourth input signal by a fourth carrier signal to downconvert a frequency of the fourth input signal from the corresponding frequency band of said one of the second input signals to the baseband, wherein phases of the third carrier signal and the fourth carrier signal are orthogonal;
filtering out noises of the third input signal outside the corresponding frequency band of said one of the second input signals, so as to generate the second real signal; and
filtering out noises of the fourth input signal outside the corresponding frequency band of said one of the second input signals, so as to generate the second imaginary signal.

20. The optical transmission method as claimed in claim 18, wherein the step of receiving the second real signal and the second imaginary signal comprises:
converting the second real signal from analog signal to digital signal to generate a second real sample sequence;
converting the second imaginary signal from analog signal to digital signal to generate a second imaginary sample sequence;
performing Fourier transform or fast Fourier transform on the second real sample sequence and the second imaginary sample sequence to generate a plurality of second symbol streams; and
compensating a channel effect of the second symbol streams, and demodulating the second symbol streams to generate a second serial digital stream.
